(19) United States
(12) Patent Application Publication
(10) Pub. No.: US 2011/0250436 A1
(43) Pub. Date: Oct. 13, 2011

(54) METHOD OF FORMING CERAMIC COATINGS AND CERAMIC COATINGS AND STRUCTURES FORMED THEREBY

(76) Inventor: John Nelson, Hebron, IN (US)

(21) Appl. No.: 12/757,368

(22) Filed: Apr. 9, 2010

(51) Int. Cl. B32B 18/00; B05D 3/02

(52) U.S. Cl. 428/325; 427/397.7; 428/446

(57) ABSTRACT

A method of forming a ceramic coating, the resulting ceramic coating, and structures produced by forming the ceramic coating on a ceramic fiber shape. The method includes forming an aqueous mixture containing water, an alumino-silicate precursor, and a dispersion of a ceramic fiber material. The alumino-silicate precursor contains a colloidal suspension of silica particles, amorphous silica particles, and micron-sized and submicron-sized alumina particles. The ceramic fiber material includes micron-sized and submicron-sized ceramic fibers. The aqueous mixture is applied to a surface of a ceramic fiber shape, after which the aqueous mixture is cured to form a ceramic coating that contains the ceramic fiber material dispersed in an alumino-silicate matrix.

### BACKGROUND OF THE INVENTION

The present invention generally relates to ceramic coatings for fiber shapes and the resulting ceramic-coated fiber shapes, nonlimiting examples of which include fire-resistant and heat-resistant structures used in residential, commercial and industrial building constructions, vehicle construction, and industrial and manufacturing applications involving the containment of hot liquids and gases.

Ceramic fiber shapes are widely used to form insulating structures, particularly for use in high temperature applications. One example is ceramic fiber shapes that use starch or latex with colloidal silica for the purpose of holding the fibers together. Structures formed by ceramic fiber shapes containing starch and/or latex typically become weak and friable if the starch and/or latex burns out, which typically occurs at temperatures of about 300° C. or more. Starch and latex are also prone to being dissolved in wet and humid environments, with the result that the fiber shape can be rendered unusable. If the starch and/or latex are burned off in service exposure to a wet environment, the ceramic fiber shape may slump and lose its shape.

In addition to or as an alternative to binders containing starch and/or latex, ceramic coatings have been applied to the exterior surfaces of fiber shapes to improve their strength and/or wear resistance. One type of ceramic coating for ceramic fiber shapes used as insulating structures generally comprises silicate compounds that are capable of chemically bonding to the fiber shape. Particular examples include silica-based coatings used on interior panels of fire-resistant doors. The coatings are often formulated to contain fillers to modify the properties of the coating for particular applications.

U.S. Pat. No. 5,164,003 to Bosco et al. discloses a silica-based coating for coating various surfaces. The coating contains a filler in a binder formed from an aqueous suspension containing a mixture of silica-based polymers, colloidal silica, and metal oxide particles. The main ingredients of the suspension are said to be an alkali metal silicate, silica gel, a cross-linking agent, and water. The suspension is capable of being cured at room temperature, and the resulting coating is said to exhibit enhanced flexibility. The cross-linking agent in the binder is described as reacting with the alkali metal silicate and silica gel to form single cross-linked O—Si—O polymer chains, which are said to be more flexible than the double cross-linked oxygen bonds in silicon dioxide.

### BRIEF DESCRIPTION OF THE INVENTION

The present invention provides a method of forming a ceramic coating, the resulting ceramic coating, and structures produced by forming the ceramic coating on a ceramic fiber or fiber shape. The coating is preferably capable of increasing the strength and rigidity of a ceramic fiber shape, and forms a very hard outer surface that resists flaking, chipping and damage from various environmental conditions.

According to a first aspect of the invention, the method includes forming an aqueous mixture containing water, an alumino-silicate precursor, and a dispersion of micron-sized and submicron-sized ceramic fibers. The alumino-silicate precursor consists essentially of a mixture of a colloidal suspension of silica particles, amorphous silica particles, and micron-sized and submicron-sized alumina particles. The aqueous mixture is preferably free of any chemical cross-linking agents. The aqueous mixture is then applied to a surface of a ceramic fiber shape, after which the aqueous mixture can be cured by drying to form a hard ceramic coating that is chemically and mechanically bonded to the ceramic fiber shape and contains the micron-sized and submicron-sized ceramic fibers dispersed in an alumino-silicate matrix.

In addition to the method described above, other aspects of the invention include the ceramic coating produced by the method described above, as well as various structures that can be produced with ceramic fiber shapes that are coated with the ceramic coating using the method described above.

According to preferred aspects of the invention, the ceramic coating is capable of being cured at room temperature, and following curing has a hard scratch-resistant surface that resists flaking and spallation when subjected to thermally cycling. In contrast to cross-linked/polymerized coatings such as taught by Bosco et al., the ceramic coating of this invention is not formed through the use of a cross-linking agent and is rigid instead of flexible. Furthermore, ceramic-coated ceramic fiber shapes produced by the invention are further capable of being fired at temperatures of up to 1000° C. or more to improve the refractory properties of the ceramic coating.

Other aspects and advantages of this invention will be better appreciated from the following detailed description.

### BRIEF DESCRIPTION OF THE DRAWINGS

FIG. 1 is a fragmentary cross-sectional view of a coating applied to a surface of a ceramic fiber shape in accordance with an embodiment of this invention.

### DETAILED DESCRIPTION OF THE INVENTION

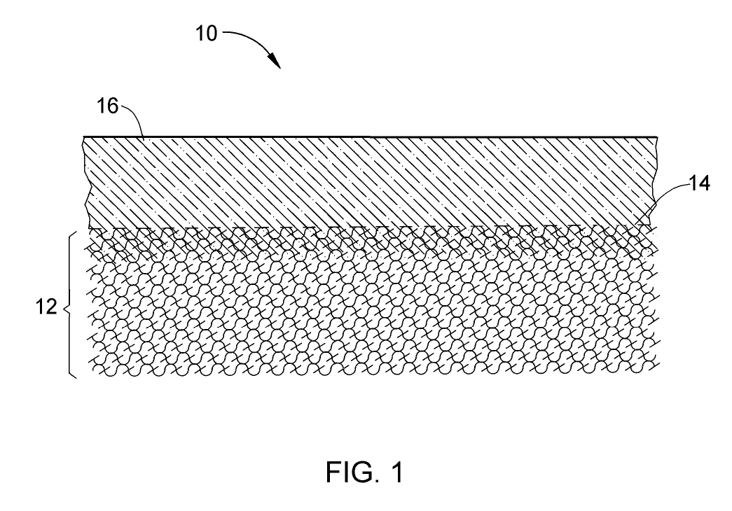

FIG. 1 represents a cross-section through a surface region of a structure 10 that includes a ceramic fiber shape 12 on whose surface 14 a ceramic coating 16 has been formed. As schematically represented in FIG. 1, the ceramic coating 16 will typically extend into a subsurface region of the shape 12. The ceramic fiber shape 12 can be fabricated according to known methods from ceramic fibers of a wide variety of compositions, and as such the ceramic fiber shape 12 and methods for its fabrication will not be described in any detail here. The shape and size of the ceramic fiber shape 12 will depend on the intended application of the structure 10. As nonlimiting examples, the structure 10 can be configured for use as an internal panel for a fire-resistant door, a fire-resistant panel, or a fire-resistant bulkhead adapted for installation in, for example, an aircraft, automobile or marine vessel. The structure 10 can also be configured as a vessel or passage (or portion thereof) adapted for containing a flowing or stationary molten metal, nonlimiting examples of which include crucibles, runners, hot topes, ingots, pour cups, dams, and baffles used in the production and refining metals, including but not limited to steels, aluminum alloys and superalloys. The structure 10 may also be configured for hot gas containment, such as a burner block, flue liner, damper or chimney liner, or as a liner for an oven, furnace or kiln. Various other applications for the structure 10 are possible and within the scope of the invention.

The ceramic coating 16 has an aluminosilicate-based composition. More particularly, the coating 16 has an alumina-silica matrix in which a ceramic fiber material is dispersed. The alumina-silica matrix may contain one or more alumina-silica based compounds. For example, and as discussed below, the alumina-silica matrix may be aluminum silicate (Al₂O₃—SiO₂; or Al₂SiO₅) or mullite (3Al₂O₃.2SiO₂), depending on whether the coating 16 is subjected to any thermal treatments.

The ceramic fiber material preferably constitutes up to about 30 weight percent of the coating 16, and more preferably about 15 to about 25 weight percent of the coating 16, with the remainder of the coating 16 being the alumina-silica matrix and optionally additional additives as discussed below. Various ceramic fiber materials may be used, depending on the particular properties desired for the coating 16. Preferred ceramic fiber materials include micron and submicron-sized ceramic fibers, which is believed to serve (at least in part) as a reinforcement for the alumina-silica matrix, yielding a ceramic-reinforced ceramic. Preferred ceramic fiber materials include alumina and silica, though it is foreseeable that additional or other ceramic fiber materials could be employed. In preferred embodiments, the relative amounts of alumina and silica fibers are varied depending on the particular composition of the fiber shape 12 and the intended use and service temperature of the structure 10. For example, an alumina:silica fiber ratio of about 30:70 is particularly suitable for service temperatures of up to about 400° C., and an alumina:silica fiber ratio of about 50:50 is particularly suitable for service temperatures of about 1000° C. to about 1200° C. Commercial sources for such ceramic fibers include Insulation Specialties of America Inc., HNT Technologies, Unifrax Corporation, Thermal Ceramics Inc., and others. Particularly preferred ceramic fibers have lengths predominantly less than twenty micrometers. Preferably, the ceramic fibers contain about 80 to 85% of micron-sized and submicron-sized fibers with lengths of up to twenty micrometers, and the remaining 15 to 20% are micron-sized fibers longer than twenty micrometers. The combination of both micron-sized and submicron-sized ceramic fibers in the coating 16 promotes the packing density of the fibers in the coating 16.

The coating 16 may also contain additives, such as metal oxide particles for the purpose of modifying the properties of the coating 16. These metal oxide particles are believed to remain as discrete particles in the coating 16, for example, as a reinforcement phase. Preferred materials for the metal oxide particles include mullite, magnesium oxide, iron oxide, and zirconium oxide. Preferred metal oxide particles have an average particle size of up to about forty-five micrometers, though the use of smaller and larger particles are foreseeable. If present, the metal oxide particles preferably constitute up to about 15 weight percent of the coating 16, and more preferably about 4 to about 10 weight percent of the coating 16.

Other optional additives for the coating 16 include various inorganic compounds other than metal oxides, for example, carbide, nitride, nitrate, sulfide, sulfate and fluoride compounds, which may be useful to favorably modify the properties of the coating 16. Preferred materials are believed to include silicon carbide, boron carbide, boron nitride, barium sulfate, barium nitrate, and sodium aluminum fluoride. The inorganic compounds preferably have average particle sizes of up to about 60 micrometers, though the use of smaller and larger particles are foreseeable. If present, the inorganic compound particles preferably constitute up to about 15 weight percent of the coating 16, and more preferably about 5 to about 12 weight percent of the coating 16. In some cases, the inorganic compounds may react or be otherwise consumed during curing. As such, the inorganic compounds may or may not be present as a discrete phase in the coating 16.

The ceramic coating 16 is formed from an aqueous mixture containing an alumino-silicate precursor in which the ceramic fiber material is dispersed. The precursor is preferably a mixture of a colloidal suspension of silica particles, amorphous silica particles, and alumina particles. The aqueous mixture does not require any chemical cross-linking agents, and therefore is preferably free of cross-linking agents. Instead, during curing of the aqueous mixture to form the coating 16, a chemical reaction appears to occur between the colloidal silica particles, amorphous silica particles and alumina particles and likely some of the ceramic fiber material to form the alumina-silica matrix of the coating 16.

Together, the colloidal silica and amorphous silica particles may constitute about 10 to about 50 weight percent of the aqueous mixture. More preferably, the colloidal silica constitutes about 20 to about 30 weight percent of the aqueous mixture, and the amorphous silica particles constitute about 5 to about 15 weight percent of the aqueous mixture. As a colloid, the colloidal silica is made up of submicron-sized particles. Commercial sources for the colloidal silica include W. R. Grace and Company, Nalco Company, and others. The amorphous silica particles are also preferably submicron-sized. A preferred amorphous silica is silica fume having a particle size of up to about sixty nanometers, with a preferred particle size range being about thirty to sixty nanometers. Commercial sources for the amorphous silica include Norchem Inc., Z-Tech LLC, and others.

The alumina particles may constitute about 10 to about 50 weight percent of the aqueous mixture, more preferably about 25 to about 35 weight percent of the aqueous mixture. Furthermore, the alumina particles are preferably present in the alumino-silicate precursor and aqueous mixture in a roughly 1:1 weight ratio to the combined amount of colloidal silica and amorphous silica. As an example, the alumino-silicate precursor preferably contains about 40 to about 65 weight percent of the colloidal silica and amorphous silica combined, with the balance essentially the alumina particles. More particularly, the alumino-silicate precursor preferably contains about 30 to about 50 weight percent of the colloidal silica, about 7 to about 25 weight percent of the amorphous silica, with the balance essentially the alumina particles. The alumina particles are preferably present as both micron-sized and submicron-sized particles to promote packing within the coating 16. A preferred alumina is calcined alumina having a particle size of about 0.16 micrometers to about 45 micrometers. Commercial sources for the alumina particles include ALCOA, Alcan Inc. (Rio Tinto Alcan), and others.

The balance of the aqueous mixture is water and the ceramic fiber material, preferably about 10 to 20 weight percent water and about 15 to 25 weight percent of the ceramic fiber material. When included, the metal oxide particles may constitute about 10 to about 60 weight percent of the aqueous mixture, and the inorganic compound particles may constitute about 5 to about 20 weight percent of the aqueous mixture. Because the ceramic fibers and metal oxide particles are reinforcement phases in the coating 16, the ceramic fibers and metal oxide particles are generally present in the aqueous mixture in the fiber and particle sizes noted above for the final coating 16.

The aqueous mixture can be prepared by blending the colloidal silica, amorphous silica particles, alumina particles, ceramic fiber material and optional additives (metal oxide and inorganic compound particles) in a high speed mixer. Water in the amounts previously noted is added to achieve a viscosity that enables the aqueous mixture to be applied to the ceramic fiber shape 12 using any desired application technique. Particularly notable application techniques include spraying, rolling, dipping, and brushing the aqueous mixture on the surface 14 of the shape 12. The aqueous mixture is preferably applied to a thickness believed to be appropriate for the intended application, with thicknesses of as little as 0.003 to about 0.006 inch (about 75 to 150 micrometers) being adequate for many applications. As a result of the application process, the aqueous mixture will typically extend below the surface 14 of the fiber shape 12, as schematically represented in FIG. 1. The extent to which the aqueous mixture penetrates the fiber shape 12 will vary, though typically the extent of penetration will be less than the thickness of the aqueous mixture coating above the surface 14 of the fiber shape 12. After application, the aqueous mixture coating is allowed to dry and undergo curing, preferably at room temperature, though it is foreseeable that lower and higher temperatures could be employed to modify the curing rate.

After curing, during which the water within the aqueous mixture evaporates, the resulting coating 16 forms a hard shell that adheres to the surface 14 of the ceramic fiber shape 12, as well as to fibers of the shape 12 beneath the surface 14. Preferred embodiments of the coating 16 are water-resistant, scratch-resistant and flame-resistant, resistant to molten metals, and resist friability at elevated service temperatures, in particular, temperatures above 200° C. The coating 16 has been shown to withstand submersion in water at pH's of about 3 to 10 for several days and show no ill affects after drying. In its as-dried form, the coating 16 is believed to be predominantly aluminum silicate (Al₂O₃—SiO₂; or Al₂SiO₅), and has been shown to enable the coated structure 10 to replace castable refractories with better insulation properties, lighter weight, and lower cost. The ceramic-coated structure 10 can undergo firing at temperatures of up to 1000° C., and possibly higher, to improve the refractory properties of the ceramic coating 16 by converting some or all of the aluminum silicate to mullite (3Al₂O₃.2SiO₂).

While the invention has been described in terms of a preferred embodiment, it is apparent that other forms could be adopted by one skilled in the art. For example, the physical configuration of the ceramic fiber shape 12 and coating 16 could differ from that shown, and processes other than those noted could be used to form the coating 16. Therefore, the scope of the invention is to be limited only by the following claims.

1. A method of forming a ceramic coating, the method comprising:
forming an aqueous mixture containing water, an alumino-silicate precursor, and a dispersion of a ceramic fiber material, the alumino-silicate precursor consisting essentially of a mixture of a colloidal suspension of silica particles, amorphous silica particles and micron-sized and submicron-sized alumina particles, the ceramic fiber material comprising micron-sized and submicron-sized ceramic fibers, the aqueous mixture being free of a chemical cross-linking agent;
applying the aqueous mixture to a surface of a ceramic fiber shape; and then
curing the aqueous mixture to form the ceramic coating and chemically and mechanically bond the ceramic coating to the ceramic fiber shape, wherein the ceramic coating contains the ceramic fiber material dispersed in an alumino-silicate matrix.

2. The method according to claim 1, wherein the alumino-silicate precursor contains about 40 to about 65 weight percent of the colloidal suspension of silica particles and the amorphous silica particles combined, with the balance essentially the alumina particles.

3. The method according to claim 1, wherein the alumino-silicate precursor contains about 30 to about 50 weight percent of the colloidal suspension of silica particles, about 7 to about 25 weight percent of the amorphous silica particles with the balance essentially the alumina particles.

4. The method according to claim 1, wherein the amorphous silica particles are silica fume particles.

5. The method according to claim 1, wherein the amorphous silica particles have particle sizes of up to sixty nanometers.

6. The method according to claim 1, wherein the amorphous silica particles have particle sizes predominantly in a range of about thirty to sixty nanometers.

7. The method according to claim 1, wherein the aqueous mixture contains up to about 30 weight percent of the ceramic fiber material.

8. The method according to claim 1, wherein the aqueous mixture contains about 15 to about 25 weight percent of the ceramic fiber material.

9. The method according to claim 1, wherein about 80 to about 85 weight percent of the micron-sized and submicron-sized ceramic fibers of the ceramic fiber material have lengths of less than twenty micrometers.

10. The method according to claim 1, wherein the micron-sized and submicron-sized ceramic fibers of the ceramic fiber material comprise alumina fibers and silica fibers.

11. The method according to claim 10, wherein the ceramic fiber material comprises, by weight, about 30 to about 50 of the alumina fibers and the balance of the ceramic fiber material is essentially the silica fibers.

12. The method according to claim 1, wherein the aqueous mixture and the ceramic coating further comprise metal oxide particles.

13. The method according to claim 12, wherein the aqueous mixture contains about 10 to about 60 weight percent of the metal oxide particles.

14. The method according to claim 12, wherein the metal oxide particles are formed of one or more materials chosen from the group consisting of mullite, magnesium oxide, iron oxide, and zirconium oxide.

15. The method according to claim 12, wherein the metal oxide particles have an average particle size of up to about forty-five micrometers.

16. The method according to claim 1, wherein the aqueous mixture and the ceramic coating further comprise inorganic compound particles.

17. The method according to claim 16, wherein the aqueous mixture contains about 5 to about 20 weight percent of the inorganic compound particles.

18. The method according to claim 16, wherein the inorganic compound particles are formed of one or more materials chosen from the group consisting of silicon carbide, boron carbide, boron nitride, barium sulfate, barium nitrate, and sodium aluminum fluoride.

19. The method according to claim 1, wherein the aqueous mixture contains, by weight, about 10 to about 20 percent water, about 20 to about 30 percent of the colloidal suspension of silica particles, about 5 to about 15 percent of the amorphous silica particles, about 25 to about 35 weight percent of the alumina particles, and about 15 to about 25 percent of the ceramic fiber material.

20. The method according to claim 19, wherein the alumino-silicate precursor consists of the colloidal suspension of silica particles, the amorphous silica particles, and the alumina particles.

21. The method according to claim 20, wherein the aqueous mixture consists of water, the alumino-silicate precursor, and the ceramic fiber material.

22. The method according to claim 1, wherein the curing step is performed at about room temperature.

23. The method according to claim 1, wherein the ceramic coating and the ceramic fiber shape to which the ceramic coating is chemically and mechanically bonded yield a structure chosen from the group consisting of internal panels for fire-resistant doors, fire-resistant panels, fire-resistant bulkheads adapted for installation in an aircraft, automobile or marine vessel, vessels and passages adapted for containing molten metals and hot gases, and liners adapted for ovens, furnaces and kilns.

24. The method according to claim 23, further comprising the step of subjecting the structure to a temperature above 200° C. without causing the structure to become soft and friable.

25. The method according to claim 23, further comprising the step of firing the structure at a temperature of above 200° C. up to about 1000° C. to improve the refractory properties of the ceramic coating.

26. The ceramic coating formed by the method of claim 1.

27. The ceramic coating according to claim 26, wherein the ceramic coating contains about 15 to about 25 weight percent of the ceramic fiber material and the balance is essentially the alumino-silicate matrix.

28. The ceramic coating according to claim 26, wherein the ceramic coating consists of the alumino-silicate matrix and the ceramic fiber material.

29. The ceramic coating according to claim 26, wherein about 80 to about 85 weight percent of the micron-sized and submicron-sized ceramic fibers of the ceramic fiber material have lengths of less than twenty micrometers.

30. The ceramic coating according to claim 26, wherein the micron-sized and submicron-sized ceramic fibers of the ceramic fiber material comprise alumina fibers and silica fibers.

31. The ceramic coating according to claim 30, wherein the ceramic fiber material comprises, by weight, about 30 to about 50 of the alumina fibers and the balance of the ceramic fiber material is essentially the silica fibers.

32. The ceramic coating according to claim 26, wherein the coating further comprises metal oxide particles.

33. The ceramic coating according to claim 32, wherein the ceramic coating contains up to about 15 weight percent of the metal oxide particles.

34. The ceramic coating according to claim 32, wherein the metal oxide particles are formed of one or more materials chosen from the group consisting of mullite, magnesium oxide, iron oxide, and zirconium oxide.

35. The ceramic coating according to claim 32, wherein the metal oxide particles have an average particle size of up to about forty-five micrometers.

36. The ceramic coating according to claim 26, wherein the ceramic coating and the ceramic fiber shape to which the ceramic coating is chemically and mechanically bonded yield a structure chosen from the group consisting of internal panels for fire-resistant doors, fire-resistant panels, fire-resistant bulkheads adapted for installation in an aircraft, automobile or marine vessel, vessels and passages adapted for containing molten metals and hot gases, and liners adapted for ovens, furnaces and kilns.
